(19) United States
(12) Patent Application Publication
(10) Pub. No.: US 2008/0003397 A1
(43) Pub. Date: Jan. 3, 2008

(54) Optical memory and method for preparing an optical memory

(76) Inventors: Markku Rasanen, Helsinki (FI); Leonid Khryashchev, Helsinki (FI)

Correspondence Address: FASTH LAW OFFICES (ROLF FASTH), 26 PINECREST PLAZA, SUITE 2, SOUTHERN PINES, NC, 28387-4301, US

(21) Appl. No.: 11/478,112

(22) Filed: Jun. 28, 2006

(51) Int. Cl. B32B 3/02

(52) U.S. Cl. 428/64.4

(57) ABSTRACT

The optical memory has nanocrystals embedded in a matrix constituting memory elements to carry bits of information. Changes have been induced in the material with light to constitute information bits in the memory. These changes are changes in the vibrational modes of the nanocrystals and they are optically readable by spectroscopic devices as a result of one or more shifted phonon bands. The method of the invention for preparing such an optical memory is performed by changing the vibration mode of the embedded nanocrystals by light in order to shift one or more phonon bands. The changes constitute information bits which are readable by spectroscopy.

### TECHNICAL FIELD

The invention is concerned with an optical memory and a method to prepare and read an optical memory.

### BACKGROUND OF THE INVENTION

Data storage refers to media and methods used to keep information available for later use. Some information will be needed right away while other will not be needed for extended periods of time. Therefore, different methods are appropriate for different uses.

A special method of recording data is used for optical memories. The fundamental requirement for a material to be able to be used for an optical memory is that an optically detectable property can be introduced (i.e. written) and later read from it. Thermal treatment, such as laser treatment, creates optically readable changes in such a memory material. The changes in the memories are then read by means of a reading operation with optical analyzers as ones and zeros by shining laser light on the memory material. An optical memory has memory elements, which can be in positions 1 and 0, i.e. they contain bits of information. A 1D (one dimensional) memory has a number of memory elements on a line (x axis). 2D memories have memory elements distributed in 2 dimensions (x,y), e.g. as a normal CD, which is a 2D memory. In 3D memories, the memory elements are distributed in a volume in three dimensions (x,y,z dimensions).

Optical memories are expected to replace electrical data buffers in optical communication systems and allow for the elimination of the accompanying optical-to-electrical conversion hardware.

The optical memories can be in the form of storage drives, disks and tape media, and the various materials used in their composition can be metals, plastics, glass, ceramics, magnetic coatings, and various thin films.

The field of optics usually describes the properties and processes with visible, infrared, and ultraviolet light; however because light is an electromagnetic wave, analogous phenomena occur in X-rays, microwaves, radio waves, and other forms of electromagnetic radiation. Optics can thus be regarded as a sub-field of electromagnetism. Optical phenomena can even be described within the quantum nature of light and these areas of optics are also related to quantum mechanics.

Raman spectroscopy is a technique enabling identification of materials used in the construction of an object, but also those appearing on the surface. It works by shining a laser beam onto the object. Most of this light is reflected off, scattered and transmitted unchanged. However a small proportion interacts with the molecules in the material in a non-linear way and is scattered inelastically. The inelastically scattered portion of light, known as the Raman effect, is filtered and collected to produce a spectrum. Each material has a unique spectrum associated with it and therefore each spectrum acts as a fingerprint to identify materials.

The energy and thus the frequency and wavelength of the scattered light is changed as the light either imparts rotational or vibrational energy to the scattering molecules or takes energy away. As the Raman spectrum is characteristic of the transmitting substance, Raman spectrometry is a useful technique in physical and chemical research, particularly for the characterization of materials. Raman active fibers, such as aramid and carbon, have vibrational modes that show a shift in Raman frequency with applied stress.

Raman spectroscopy studies vibrational, rotational, and other low-frequency modes in a system. It relies on Raman scattering of monochromatic light, usually from a laser in the visible, near infrared, or near ultraviolet range. Phonons or other excitations in the system are combined with the laser light, resulting in the energy of the laser phonons being shifted up or down (i.e. anti-Stokes and Stokes shifts). The shift in energy gives information about the phonon modes in the condensed matter system. Infrared spectroscopy yields similar, but complementary information.

In physics, a phonon is a quantized mode of vibration occurring in a rigid crystal lattice, such as the atomic lattice of a solid. Phonons are a quantum mechanical version of a special type of vibrational motion. Any arbitrary vibrational motion of a lattice can be considered as a superposition of elementary vibrations with various frequencies. Vibrational information is very specific for the chemical bonds in molecules. It therefore provides a fingerprint by which the molecule can be identified.

In solid state physics, spontaneous Raman spectroscopy is e.g. used to characterize materials, measure temperature, and find the crystallographic orientation of a sample. The polarization of the Raman scattered light with respect to the crystal and the polarization of the laser light can be used to find the orientation of the crystal, if the crystal structure is known. A given solid material has characteristic phonon modes that can identify it.

Detectable optical properties that are possible to be prepared in a medium might consist of refractive index, reflectivity or extinction index by means of a laser beam. Thereby information can be recorded.

The materials used in optical memories can be based on e.g. Tellurium(Te)/Tellurium oxide (TeO₂), or on film materials containing e.g. Palladium(Pd), Germanium (Ge), Antimony (Sb) and Tellurium (Te). Also silicon based optical nanocrystal memory offers the possibility for implementation in such memories. A nanocrystal is a crystalline material with dimensions measured in nanometers, i.e. it is a nanoparticle with a structure that is mostly crystalline.

Nanocrystals of carbon, optionally alloyed with a metal, together with an oxidizer component are oriented and information can be read by means of a radiation beam having a certain polarization with respect to the orientation of the nanocrystals, thereby having created information areas.

Nanocrystalline silicon has specific structural, electronic, and optical properties—they strongly absorb light in the near UV range and re-emit visible light that has its color determined by both the nano size and surface chemistry. It has a broad excitation spectrum compared to other materials used in optical memories. These factors make nanocrystalline silicon a strong candidate for a major application of nanotechnology.

There are changes in the optoelectronic properties when oxygen is absorbed onto hydrogenated Silicon nanocrystal. E.g. a SiO₂ matrix influences the physical properties of a Si nanocrystal e.g. explaining the strong photoluminescence response.

Silicon nanocrystals in SiO₂ represent an optoelectronic material produced within Si technology and showing optical gain around 1,6 eV.

Repeating deposition of Si and SiO₂ ultrathin layers provides an approach to prepare Si/SiO₂ superlattices with adjustable properties and thermal annealing promotes silicon crystallization.

Pulsed laser annealing can produce polycrystalline silicon from the amorphous phase and crystallization presumably occurs via silicon melting.

Free-standing film materials, in contrast to samples on substrates, can be heated efficiently with continuous-wave laser radiation, whereby different phenomena occur.

One relevant phenomenon is the change of the photoluminescence of the material. Some known silicon based memory devices are therefore read optically by monitoring the photoluminescence (PL) intensity by “charging” the nanocrystals in various ways. Thus, the PL, which then varies according to the average charge state of the nanocrystal embedded in the device, can be measured. The variations are achieved by suppression of the photoluminescence in charged nanocrystals.

Known optical storages mostly stores one-dimensional information or two-dimensional information. Newer reports announce a three-dimensional approach by using photochromic materials, which change color when excited by lasers.

Further development of the optical memories is continuously needed to increase the stability of information recorded by increasing the decay time and also to find more cost efficient media and accurate reading techniques.

### SUMMARY OF THE INVENTION

The invention consists of an optical memory containing nanocrystals embedded in a matrix constituting memory elements to carry bits of information. Changes have been induced in the material with light to constitute information bits in the memory. These changes are changes in the vibrational modes of the nanocrystals and they are optically readable by spectroscopic means as a result of one or more shifted phonon bands.

The method of the invention for preparing such an optical memory is performed by changing the vibration mode of the embedded nanocrystals by light in order to shift one or more phonon bands, the changes constituting information bits, which is readable by spectroscopic means.

In practice, the changes can be induced by laser irradiation and the reading is performed by Raman spectroscopy. The optical memory is prepared by repeated laser treatments at temperatures above the melting point of the nanocrystals followed by crystallization steps, thereby preparing a memory based on energetically shifted phonon bands. Some areas of the material is irradiated by laser light making additional changes. The different laser treatment steps lead to phonon bands at different spectral positions and in different spatial areas. The phonon band positions are read by Raman spectroscopy and converted into electronically readable ones and zeros. The Raman intensities in given spectral intervals are measured (after the high and low temperature laser treatments) as a function of the three-dimensional position in the storage material and the intensities are converted into electronically readable ones and zeros. The treatment at one laser power of a certain level leads to one type of changes (writing) and the treatment at another laser power level leads to other changes (reading).

An advantageous memory consists of nanocrystals of e.g. Silicon (Si) embedded in a transparent SiO₂ matrix, but also other nanocrystals and matrices can be used, such as Germanium (Ge) crystals in a Germanium oxide matrix.. Silicon nanocrystals of wanted size embedded in a SiO₂ matrix can be prepared by known silicon technology. In the invention, it is a question about achieving a compressive stress of the nanocrystals in a transparent matrix. In experiments, Si nanocrystals in the SiO₂ matrix first melt and when they crystallize from the liquid phase, a stress occurs.

Nanocrystals possess special properties, which in the invention are manipulated by laser treatment thereby inducing optically detectable changes. The treatment melts nanocrystals in a solid matrix and, after the laser treatment, when crystallization of the nanocrystals from the liquid phase occur, the crystals take up a bigger volume than the liquid phase and get a stress. This is dependent on different melting temperatures of the nanocrystals and the embedding matrix. The stress of the nanocrystals influences their spectroscopic properties for instance by shifting the phonon band markedly.

The phonon band is shifted because of the stress. The vibrational mode of the crystals has changed and the changed and the Raman band is shifted compared to the unstressed state. Because of the changes of the phonon mode, the changes can be read by Raman spectroscopy, which is performed by laser irradiation sufficiently below the Si melting temperature.

The induced changes mean that the laser treatment leaves a signature to the embedded nanocrystals, whereby writing into the treated Si-based optical material is possible. Thus, the invention allows making an optical memory with a very high density and a very long retention time, which can be written, erased and read by optical means.

When the laser irradiation is used for reading the changes by Raman spectroscopy, the reading temperature is low enough, ca ten times lower than the melting temperature, otherwise the information might be damaged.

When the intention is to remove (erase) the changes, the removal is performed by laser treatment below the melting temperature, but at a temperature high enough for the stress to release. New information (i.e. new changes) can then be induced again with laser treatment above the melting temperature with subsequent crystallization, which cause a new stress.

The invention provides an ideal optical memory due to following reasons:
1. Silicon (Si) can be used in the preparation of these materials. Si is one of the most abundant elements on earth. No polluting materials are needed to be used in the product of the invention.
2. The durability of the changes in the materials in the invention is superior compared to the optical memories suggested to date. The estimated thermal lifetime at room temperature exceeds the lifetime of our galaxy, and at temperatures of several hundreds of degrees it is hundred years.
3. The memory material of the invention can be manufactured directly integrated to the Si based electronic components, which opens novel applications.
4. The memory elements can be of a very little size limited only by the focal area of the laser beam.
5. The memory elements can be made three-dimensional, which increases the information density enormously.

A detailed non-restrictive description of the invention follows. The invention is further illustrated by means of an example.

### BRIEF DESCRIPTION OF THE DRAWINGS

FIG. 1A presents Raman spectra of different products used in the invention

FIG. 1B shows Raman band intensity after various laser annealing steps above and below Si melting temperature

FIG. 2 shows a typical temperature dependence on the laser power

FIG. 3A shows the Raman shift as a function of laser annealing time showing the temperature induced realaxation of Si nanocrystal stress

FIG. 3B presents the characteristic stress decay time as a function of the reverse temperature

### DETAILED DESCRIPTION

The invention consists of an optical memory having one or more optically readable spectroscopic properties.

The optical memory preferably consists of nanocrystals of e.g. Silicon (Si) embedded in a transparent matrix, e.g. a SiO₂ matrix. The spectroscopic changes consists of changing the position of the phonon band by changing the pressure of the embedded nanocrystal by means of laser treatment with stress at nanoscale level.

Laser radiation from e.g. a continuous-wave Ar⁺ laser radiation at a temperature above the melting point of the nanocrystal material melts the nanocrystals in the free-standing matrix. Substrate-supported materials can be melt by pulsed laser radiation.

In a normal situation, a nanocrystal has a certain stress inside the solid matrix. The laser treatment causes melting of the nanocrystals and the stress is released at this high temperature. When the Si crystals crystallize from the liquid phase a compressive stress for the nanocrystals appear because liquid and solid particles have different volumes.

In the case of Si/SiO₂ material, the laser annealing above the Si melting temperature melts Si inclusions and releases stresses in the vicinity. After crystallization of the melt particle, its volume increases by ca 10%, resulting in a compressive stress. This stress can be estimated in the approximation of a spherical Si particle with volume V_{S} into a SiO₂ sphere with volume V_{M}:

$$P = \frac{{V}_{S} - {V}_{M}}{{V}_{S} / K + 3 {V}_{M} / 4 {G}^{′}}$$

where K is the Si modulus of compression (ca 100 Gpa) and G is the shear modulus of silica (28 GPa). Because the measurements are performed at room temperature, the values of V_{S} and V_{M} should be corrected to different thermal expansion coefficients of Si and SiO₂ (ca 3×10⁻⁶ and 0,5×¹⁰⁻⁶ 1/° C., respectively). By collecting all numbers, we estimate a compressive stress of 2,3 GPa, which upshifts the Raman band by 7 cm⁻¹. With respect to the estimation of the stress.

In order to erase the changes laser annealing below the Si melting temperature can be used (but in a temperature high enough for the stress to release) and new changes can be induced by laser annealing above the melting temperature and subsequent recrystallization.

The temperature of the laser irradiation can be estimated. Using the measured anti-Stokes to Stokes intensity ratio:

$$\frac{{I}_{AS}}{{I}_{S}} = - ( \frac{{E}_{R}}{kT} )$$

where E_{R} is the phonon energy and T is the temperature in the irradiated area. The experimental correlation between the I_{AS}/I_{S} ratio and the temperature for crystalline Si can be verified.

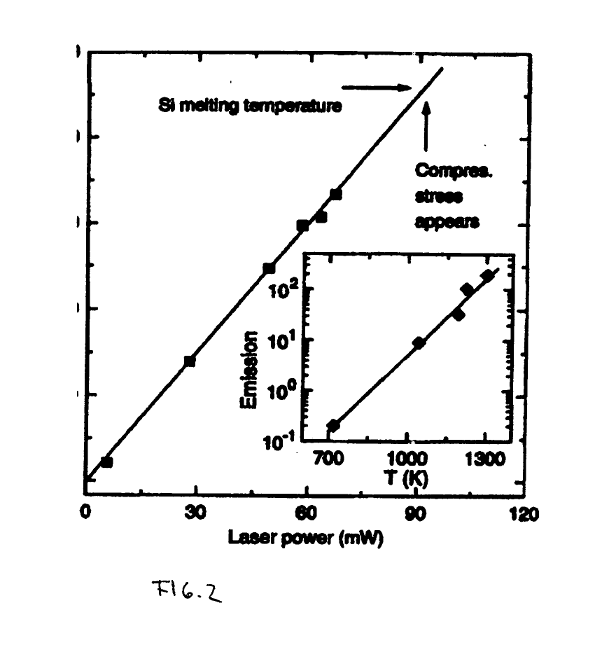

This method can be used to extract the temperature in the laser sport. An example is presented in FIG. 2 and the temperature is a linear function of the laser power. The laser induced temperatures are quite high and a laser power of ca 100 mW through the 40 μm spot provides the Si crystalline melting temperature (1685 K). As shown in the insert of FIG. 2, the hot sport gives thermal emission, whose intensity is an exponential function of temperature, which confirms the high laser induced temperatures.

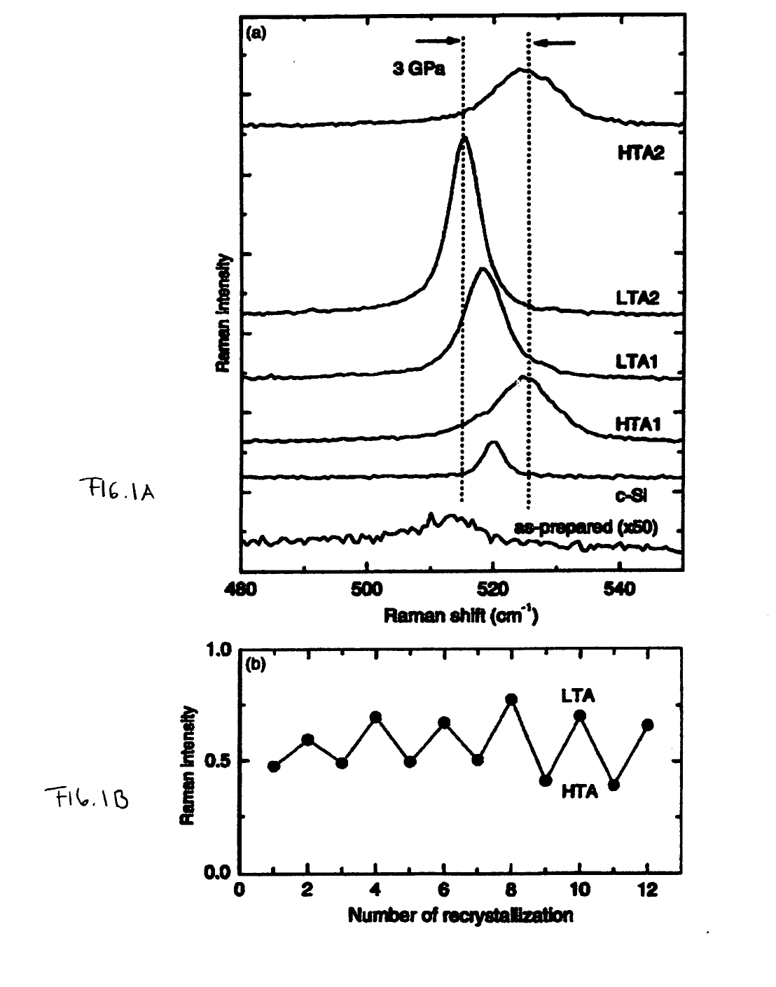

Based on these results, the laser manipulations presented in FIG. 1 can be explained.

FIG. 1A shows Raman spectra of silicon. Shown are (from bottom to top), the spectra of the as-prepared free-standing superlattice, a crystalline Si wafer, the free-standing superlattice after short laser heating above Si melting temperature (HTA1), the same sample after 45 min at 1010 K (LTA1), after additional laser annealing below Si melting temperature (LTA2) and after additional melting temperature above Si melting temperature (HTA2). The laser excitation power is 5 mW giving only a small effect on the Raman bands.

The invention will now be described by means of some practical examples by means of test results. The invention is not restricted to the details of the detailed description.

### EXAMPLE

The Si/SiO₂ superlattice was deposited onto a Si wafer using molecular-beam deposition, being one of a number of methods of thin-film deposition, in which molecules are evaporated and deposited onto a wafer. The deposition consisted of 500 repeats of 2 nm thick Si and SiO₂ layers. The deposition procedure was previously verified with transmission electron microscopy.

A sample of the resulting product was thermally annealed at 1100° C. for 1 h in a nitrogen atmosphere. Silicon dioxide patterns were formed on the sample's back side using photolitography. Then the Si substrate between the patterns were chemically etched producing areas of free-standing film material supported by thin Si stripes.

The Raman spectra were recorded with an Ar⁺ laser (488 nm, Omnichrome 543-AP), a single stage spectrometer (Acton SpectraPro 500I, resolution 3 cm⁻¹), and a charge coupled device camera (Andor InstaSpec IV). The laser beam was focused to a spot of 40 μm. Before later treatment, the as-prepared free-standing superlattice contains some amount of Si nanocrystals as indicated by relatively narrow Raman bands in FIG. 1A (lowest trace).

In a conventional phonon confinement model, the Raman spectrum suggests a size of 4 nm for the Si crystals and the obtained Raman intensity is small compared to the signal from crystalline silicone, which is typical for thermally annealed materials of similar composition.

After a short exposure to intense laser radiation (>100 mV through 40 μm, high-temperature annealing (HTA1 in FIG. 1A), the crystalline peak strongly increases indicating structural re-organisation, and the Raman band shifts to higher energy (525 cm⁻¹), which is above the scattering energy of crystalline silicon.

Upon exposure to a weaker laser power (40-80 mV, low temperature annealing (LTA1 in FIG. 1A), the Raman band shifts to a lower energy as shown in FIG. 1A and the lowest Raman shift achieved is 515 cm⁻¹.

The next high temperature annealing (HTA2 in FIG. 1A) recovers the Raman shift of 525 cm⁻¹.

The preparation of the high-energy band and its shift to lower energies can be repeated many times. The corresponding Raman intensities show practically no degradation as seen in FIG. 1B. FIG. 1B shows the Raman band intensity after various laser annealing steps above (HTA) and below (LTA) Si melting temperature.

The Raman intensities were measured after HTA and LTA as a function of the position of the Raman band. Taking into account that the recorded profile is a convolution of the affected spot and the probing laser beam, the observed structural effect of laser annealing is fully localized at the laser beam central part.

The Raman scattering at 518 cm⁻¹ corresponds to unstressed Si nanocrystals with a diameter of ca 5 nm so that the band at 525 cm⁻¹ agrees with the estimated stress. The Raman band is additionally broadened due to stress distribution. The formation of Si nanocrystals with sizes larger than the as-deposited Si layers is due to merging of SiO₂ layers observed upon rapid thermal annealing of similar samples.

The appearance of the compressive stress on Si nanocrystals correlates very well in the temperature scale with Si melting as can be seen in FIG. 2, supporting the conclusions on laser melting of Si nanocrystals in a SiO₂ matrix and the origin of the observed compressive stress.

The laser annealing temperature below the Si melting temperature (LTA) shifts Raman bands down in energy to ca 516 cm⁻¹. The Si nanocrystal particles prepared in LTA probably have, at room temperature, a tensile stress due to different thermal expansion coefficients of Si and SiO₂. The estimate based on the above equation gives a tensile stress up to 0,5 GPa at room temperature, which shifts the band down in energy by ca 2 SiO₂ from the unstressed position. Altogether, the estimated stress difference between HTA and LTA is 2,8 GPa as can be seen in FIG. 1. The presented estimate is a simplification first of all due to a complicated morphology of the Si nanocruystal embedded in a SiO₂ matrix.

However, the good agreement with experiment is remarkable. In any case, the Raman spectra show laser manipulation with Si nanocrystal stress in the 3 GPa range.

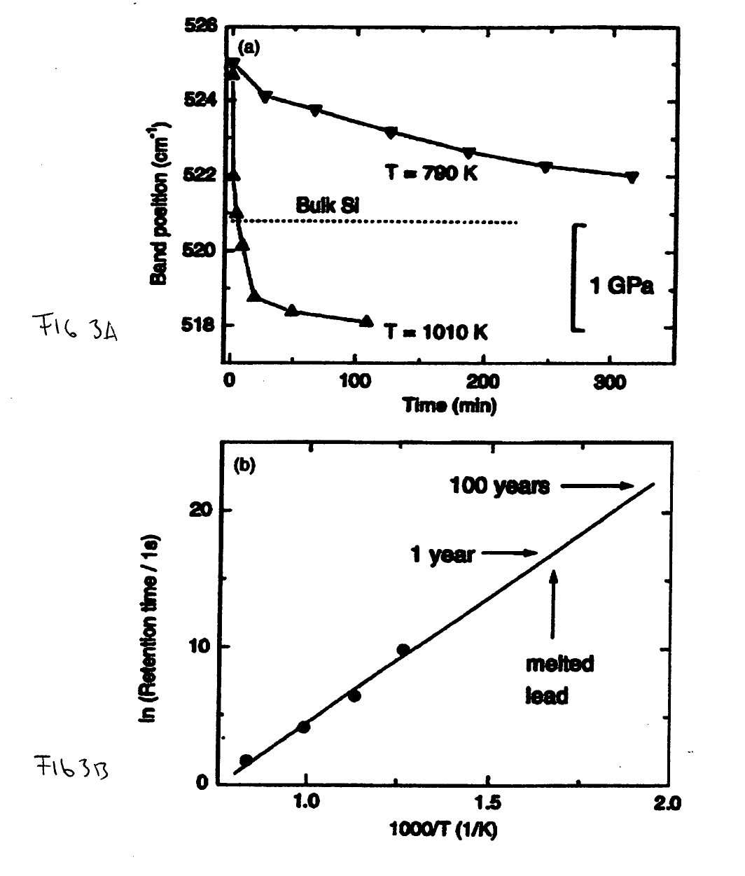

FIG. 3A shows Raman shift as a function of laser annealing at 790 and 1010K showing the temperature-induced relaxation of Si nanocrystal stress. The stress scale is marked. The temperatures were obtained from the anti-Stokes to Stokes intensity ratios. The horizontal dotted line shows the Raman shift of crystalline Si. The presented Raman shifts are measured with a laser power of 5 mV. The stress relaxation kinetics is presented in FIG. 3A for two laser-induced temperatures. The release of stress is very temperature dependent, and it becomes practically undetectable at temperatures below 700 K. We characterize the decay by the time needed for relaxation of 1 GPa, which corresponds to a change of the band deposition from 525 to 522 cm⁻¹.

The mechanism of compressive stress relaxation of Ge nanocrystals in SiO₂ was studied, and the diffusive flux of matrix atoms away from the stressed particle with the 2,6 eV activation energy was suggested as the stress-decay mechansim. For Si nanocrystals in Silica, the value for activation energy (1,6 eV) is smaller, and this can be due to different sample preparation leading to a larger initial stress in our case and differences in local morphology.

The laser controlled stress allows writing and erasing data and its reading by optical means, i.e. makes it possible to make optical memories. These manipulations are provided by micro Raman mapping, which is a well developed technique with submicron resolution in three dimensions.

For instance, while reading data, one can make mapping of Raman intensity at 525 cm⁻¹ from stressed Si nanocrystals. The potential data density can be much higher than in the examples presented later on in this text. Indeed, silicon melting with submicron dimensions has been demonstrated

A practically infinite retention time for the Si nanocrystals is important. FIG. 3B shows the characteristic stress decay time as a function of the reversed temperature. FIG. 3B presents this retention time as a function of 1 FT. The slope of the line suggests an activation energy of (1,6±0,2) eV. The stress lifetime should be practically infinite for temperatures <500K.

While the present invention has been described in accordance with preferred compositions and embodiments, it is to be understood that certain substitutions and alterations may be made thereto without departing from the spirit and scope of the following claims.

1. An optical memory containing nanocrystals embedded in a solid matrix constituting memory elements to carry bits of information, comprising:
information bits representing light induced changes in the vibrational modes of the nanocrystals, which changes are optically readable by spectroscopy as a result of one or more shifted phonon bands.

2. An optical memory of claim 1, wherein the shifted phonon bands occur at different positions (cm⁻¹) convertible into electronically readable ones and zeros.

3. An optical memory of claim 1, wherein the memory elements form a three-dimensional network.

4. An optical memory of claim 1, wherein the optical memory consists of nanocrystals of Silicon (Si) embedded in a SiO₂ matrix.

5. A method of preparing and reading and optical memory containing nanocrystals embedded in a solid matrix constituting memory elements to carry bits of information, comprising:
changing the vibration mode of the embedded nanocrystals by light in order to shift one or more phonon bands, the changes constituting information bits, which are readable by spectroscopy.

6. The method of claim 5, wherein the optical memory is prepared by embedding Si nanocrystals in a SiO₂ matrix.

7. The method of claim 5, wherein the vibration mode is changed by recrystallizing the memory material.

8. The method of claim 7, wherein the changes in the embedded nanocrystals are induced by laser treatment.

9. The method of claim 8, wherein the laser treatment is performed in a temperature above the melting temperature of the nanocrystal material.

10. The method of claim 9, wherein the method further comprises preparing the optical memory by repeated laser treatments at temperatures above the melting point of the nanocrystals followed by crystallization, thereby preparing a memory having higher-energy phonon bands and their shifts to lower energy phonon bands as a result of additional laser treatments.

11. The method of claim 5, wherein the changes are read by Raman spectroscopy.

12. The method of claim 5, wherein the reading temperature is low enough not to remove the readable changes.

13. The method of claim 5, wherein the method further comprises converting the phonon bands read by Raman spectroscopy into electronically readable ones and zeros.

14. The method of claim 13, wherein the method further comprises measuring the Raman intensities measured after the high and low temperature laser treatments as a function of the position of the Raman band and converting the intensities into ones and zeros.

15. The method of claim 5, wherein in order to remove previous changes, laser treatment below the melting temperature of the nanocrystals high enough to remove the changes is performed.
